(19) United States
(12) Patent Application Publication
(10) Pub. No.: US 2015/0117604 A1
(43) Pub. Date: Apr. 30, 2015

(54) BALANCING IN AN X-RAY TUBE

(71) Applicant: KONINKLIJKE PHILIPS N.V., EINDHOVEN (NL)

(72) Inventor: Wolfgang Chrost, Hamburg (DE)

(73) Assignee: KONINKLIJKE PHILIPS N.V., EINDHOVEN (NL)

(21) Appl. No.: 14/397,880

(22) PCT Filed: May 6, 2013
(86) PCT No.: PCT/IB2013/053616

§ 371 Date: Oct. 30, 2014

Related U.S. Application Data
(60) Provisional application No. 61/649,993, filed on May 22, 2012.

(51) Int. Cl. H01J 35/10

(52) U.S. Cl. CPC H01J 35/103; H01J 2235/1073
USPC 378/62; 378/132

(57) ABSTRACT

The present invention relates to an X-ray tube with an active balancing arrangement, hi order to provide improved balancing for a minimized imbalance during operation, an X-ray tube (10) with an active balancing arrangement (12) is provided, comprising a rotating anode arrangement (14), a bearing arrangement (20, 22, 24), a driving arrangement (26, 28, 30) for rotating the anode arrangement, an imbalance detection arrangement (32), and active balancing means (34, 36, 38, 40, 42). The bearing arrangement is provided as a fixed bearing of the rotating anode arrangement for supporting the rotating anode arrangement. The imbalance detection arrangement is configured to detect an imbalance of the anode. The active balancing means are electro-magnetic balancing means configured to provide a magnetic field and to apply magnetic eccentricity forces to the rotating arrangement.

### FIELD OF THE INVENTION

The present invention relates to active balancing in an X-ray tube, and in particular to an X-ray tube with an active balancing arrangement, to an X-ray imaging system, to a method for actively balanced rotation of an anode of an X-ray tube, and to a computer program element as well as to a computer readable medium.

### BACKGROUND OF THE INVENTION

In X-ray tubes with a rotating anode arrangement, imbalance may be caused by eccentricities. For example, this may be caused by mechanical eccentricities, for example of the rotating or the main part, or also by shaft run out due to rotation. During the production, i.e. the assembly of an X-ray tube, mechanical eccentricity may be reduced by balancing in two levels. Further, for example, WO 2011/039662 describes the adjustment of eccentricities after final assembly. However, also the processing and operation of an X-ray tube causes thermo-mechanical stresses to the rotating parts, mainly the anode disc. This can lead to an additional increase of the mechanical eccentricity. Still further, in relation with increased demands of computer tomography apparatus, where high rotation frequencies are desired, in addition to a rotation on a gantry around an object, vibration caused by imbalance may lead to rotor dynamic problems for the X-ray tube itself as well as also to a high noise level for the system.

### SUMMARY OF THE INVENTION

Hence, there is a need to provide improved balancing for a reduced imbalance during operation.

The object of the present invention is solved by the subject-matter of the independent claims, wherein further embodiments are incorporated in the dependent claims.

It should be noted that the following described aspects of the invention apply also for the X-ray tube with an active balancing arrangement, the X-ray imaging system, the method for actively balanced rotation of an anode of an X-ray tube, as well as the computer program element and the computer readable medium.

According to a first aspect of the present invention, an X-ray tube with an active balancing arrangement is provided, comprising a rotating anode arrangement, a bearing arrangement, a driving arrangement for rotating the anode arrangement, an imbalance detection arrangement, and active balancing means. The bearing arrangement is provided as a fixed bearing of the rotating anode arrangement for supporting the rotating anode arrangement. The imbalance detection arrangement is configured to detect an imbalance of the anode. The active balancing means are electro-magnetic balancing means configured to provide a magnetic field and to apply magnetic eccentricity forces to the rotating arrangement.

The bearing arrangement is provided as a fixed bearing of the rotating anode arrangement for supporting stable mechanical positioning of the rotating anode and therewith a stable positioning of the focal spot.

The term “fixed” bearing relates to a stable and continuously provided bearing such as a spiral groove bearing or ball bearings and needle bearings. The balancing is provided in addition to that fixed bearing to reduce forces within the rotating system and the interface to the tube. The fixed bearing may also be referred to as a stiff bearing.

According to an exemplary embodiment, a control unit is provided, and the active balancing means are controlled according to signals provided by the imbalance detection arrangement.

According to an exemplary embodiment, the active balancing means comprise at least three balancing arrangements provided in at least two different planes, which planes are perpendicular to an axis of rotation.

For example, the balancing arrangements may be provided as coil arrangements.

According to an exemplary embodiment, the driving arrangement comprises a rotor and a stator, and the active balancing means are configured to act upon magnetically activatable parts of the rotor. The term “act” relates to affect the rotor, i.e. to influence the rotor and the magnetic forces acting upon the rotor.

According to an exemplary embodiment, the driving arrangement comprises a rotor and a stator, and the active balancing means are provided integrally with the stator.

According to an exemplary embodiment, the magnetic eccentricity caused by the active balancing means is adaptable in position and amplitude.

According to a second aspect of the present invention, an X-ray imaging system is provided, comprising an X-ray source, an X-ray detector, and a processing unit. The X-ray source is provided as an X-ray tube according to the above-mentioned examples. The processing unit is provided to control the rotation of the anode and the balancing of the anode by the active balancing means.

According to a third aspect, a method for actively balanced rotation of an anode of an X-ray tube is provided, comprising the following steps:
a) rotating an anode arrangement;
b) detecting an imbalance; and
c) adapting active balancing means depending on the detected imbalance. For the rotation, a bearing arrangement is provided as a fixed bearing of the rotating anode arrangement for supporting the rotating anode arrangement. The active balancing means are electro-magnetic balancing means. In step c), the active balancing means are providing and applying magnetic eccentricity forces to the rotating arrangement.

According to an exemplary embodiment, the application of the magnetic eccentricity forces to the rotating arrangement results in compensating the detected imbalance.

According to an aspect of the present invention, mechanical imbalance as such can be accepted, but will be compensated by well defined rotating magnetically eccentricity. For example, additional coils can add this magnetic field in two levels. The frequency of this field will be the rotation frequency of the rotor and it has to be anti-dromic to the mechanical eccentricity, i.e. opposite to the momentum forces resulting in the imbalance. For example, there are at least three coils in two different levels. According to an aspect of the invention, the magnetically eccentricity is adjustable in position and amplitude, so also changes during lifetime can be covered. Further, it is also provided to support the system in case of passing through resonances. According to an aspect of the present invention, an adjustable magnetic field is provided that, in case of a proper balanced rotating part, would lead to an induced imbalance. However, the induced imbalance is used for compensating of real imbalancement, in order to provide a balanced rotation of a rotating anode arrangement.

### BRIEF DESCRIPTION OF THE DRAWINGS

Exemplary embodiments of the invention will be described in the following with reference to the following drawings:

FIG. 1 shows an example of an X-ray tube in a cross-section;

FIG. 2 shows a further example of an X-ray tube with an active balancing arrangement;

FIG. 3 shows an example for the arrangement of balancing means in at least two different planes;

FIG. 4 shows a further example of an X-ray tube with an active balancing arrangement;

FIG. 5 shows a further embodiment of an actively balanced X-ray tube;

FIG. 6 shows an exemplary embodiment of an X-ray imaging system;

FIG. 7 shows basic steps of an example of a method for actively balanced rotation of an anode of an X-ray tube; and

FIG. 8 shows further examples of the method according to FIG. 7.

### DETAILED DESCRIPTION OF EMBODIMENTS

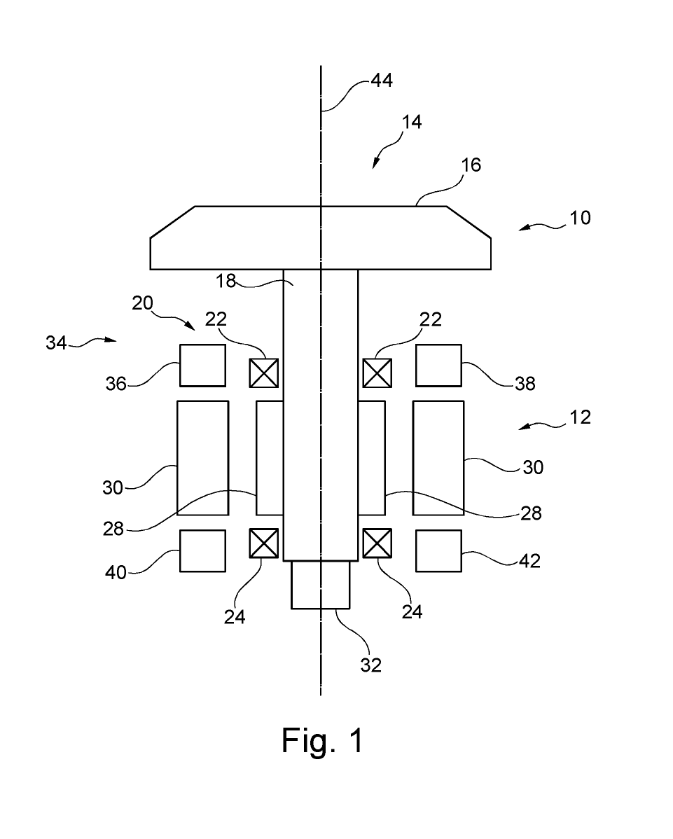

FIG. 1 shows an X-ray tube 10 with an active balancing arrangement 12. The active balancing arrangement 12 comprises a rotating anode arrangement 14, for example an anode disc 16 connected to a rotating shaft 18. Further, a bearing arrangement 20 is provided, for example comprising upper bearings 22 and lower bearings 24. It must be noted that the terms “upper” and “lower” relate to the arrangement with respect to the drawing sheet, and not to the actual arrangement in space. Further, a driving arrangement 26 for rotating the anode arrangement 14 is provided, for example comprising a rotor 28 connected to the shaft 18, and a stator 30. Further, an imbalance detection arrangement 32 is provided, and active balancing means 34, for example a first active balancing element 36, a second active balancing element 38, a third active balancing element 40, and a fourth active balancing element 42.

The bearing arrangement 20 is provided as a fixed bearing of the rotating anode arrangement 14 for supporting the rotatable anode arrangement. The imbalance detection arrangement 32 is configured to detect an imbalance of the anode. It must be noted that FIG. 1 only schematically shows the imbalance detection arrangement 32. However, also other locations or also multiple locations for detecting an imbalance can be provided.

The active balancing means 34 are electro-magnetic balancing means configured to provide a magnetic field and to apply magnetic eccentricity forces to the rotating arrangement.

Further, an axis of rotation 44 is indicated.

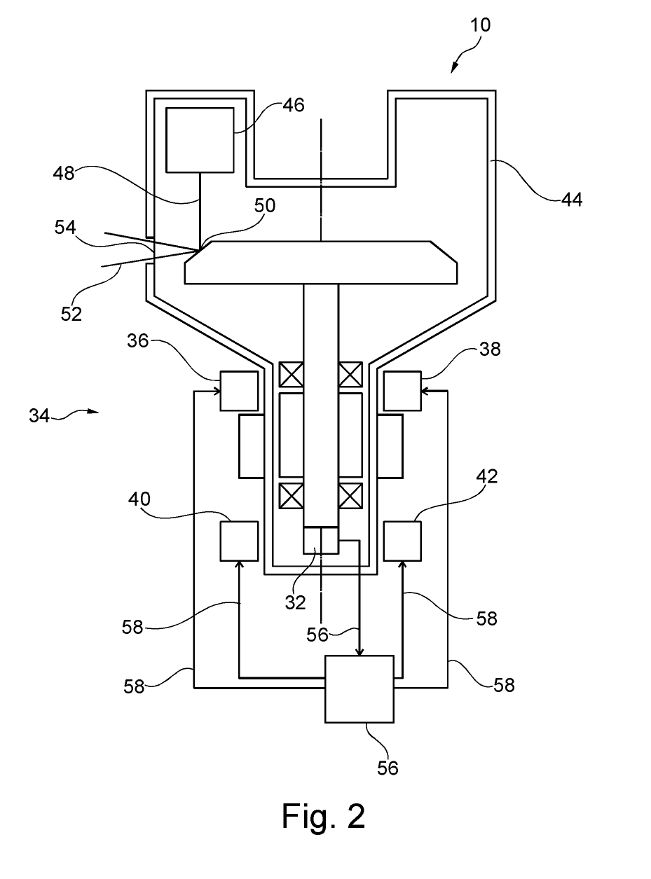

FIG. 2 shows a further example of an X-ray tube 10, also showing an enclosure 44, i.e. a housing for generating a vacuum inside. A cathode 46 is provided to emit an electron beam 48 towards a focal spot 50 to generate a beam of X-ray radiation 52, emanating from an X-ray window 54 in the housing 44 that otherwise also acts as a shielding.

Further, a control unit 56 can be provided, and the active balancing means 34, i.e. the first, second, third and fourth active balancing element 36, 38, 40, and 42, are controlled according to signals provided by the imbalance detection arrangement 32, which provision of signals is indicated with an arrow 56. The controlling of the active balancing means is indicated by respective arrows 58.

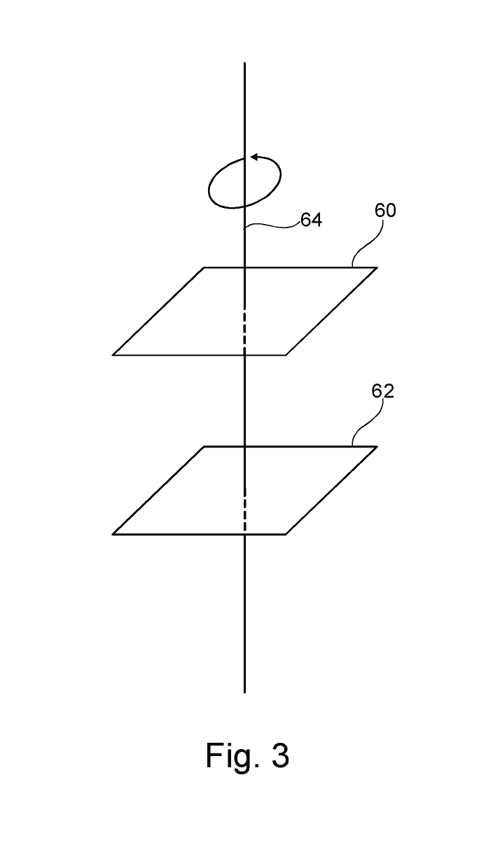

As indicated in FIG. 3, the active balancing means 34 comprise at least three balancing arrangements provided in at least two different planes 60, 62, which planes are perpendicular to an axis of rotation 64. Thus, a compensation for eccentricities is provided in all directions.

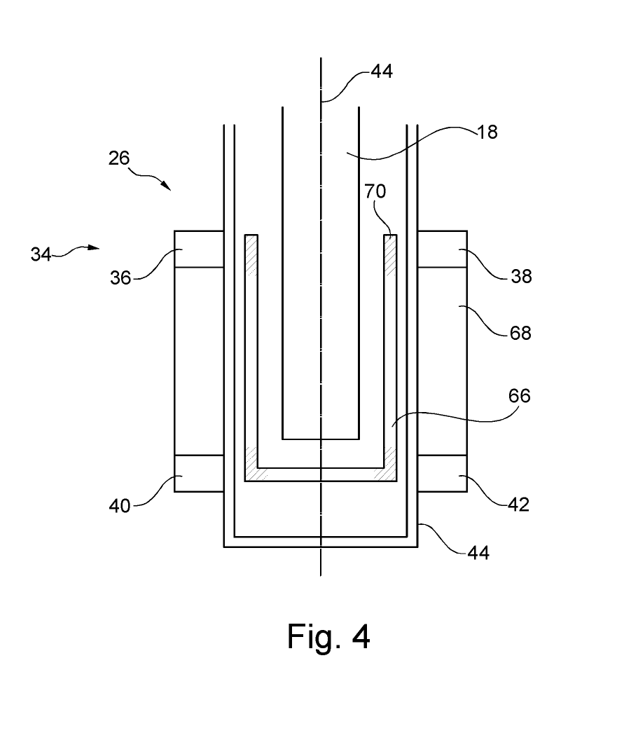

As shown in FIG. 4, the driving arrangement 26 comprises a rotor 66 and a stator 68. The active balancing means 34 are configured to act upon magnetically activatable parts of the rotor, for example regions 70 in vicinity of the active balancing elements 36, 38, 40, and 42.

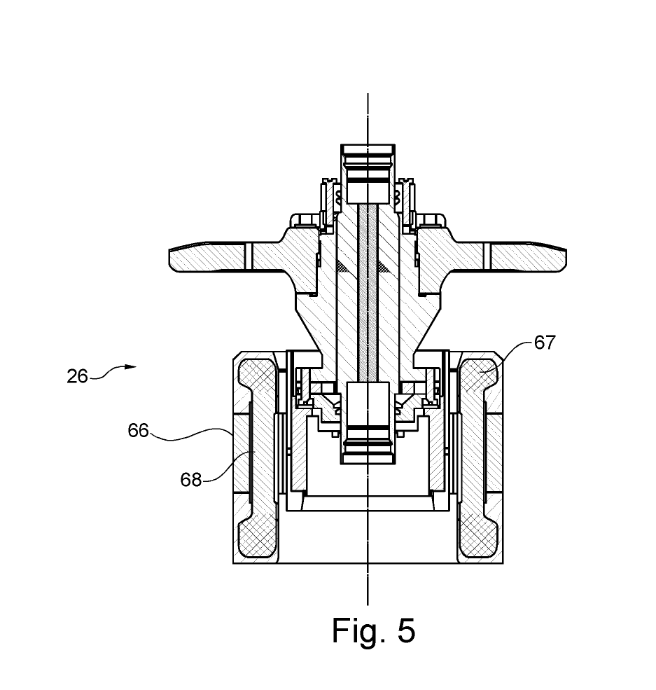

As shown in FIG. 5, the driving arrangement 26 comprises a rotor 66 and a stator 68, and the active balancing means are provided integrally with the stator. For example, in the edge portions of the stator, as shown in the cross-section of FIG. 5, additional coil windings 67 can be provided in order to generate a magnetic field for counter balancing purposes.

According to a further example, applicable in particular also in combination with the above mentioned examples, the magnetic eccentricity caused by the active balancing means 34 is adaptable in position and amplitude.

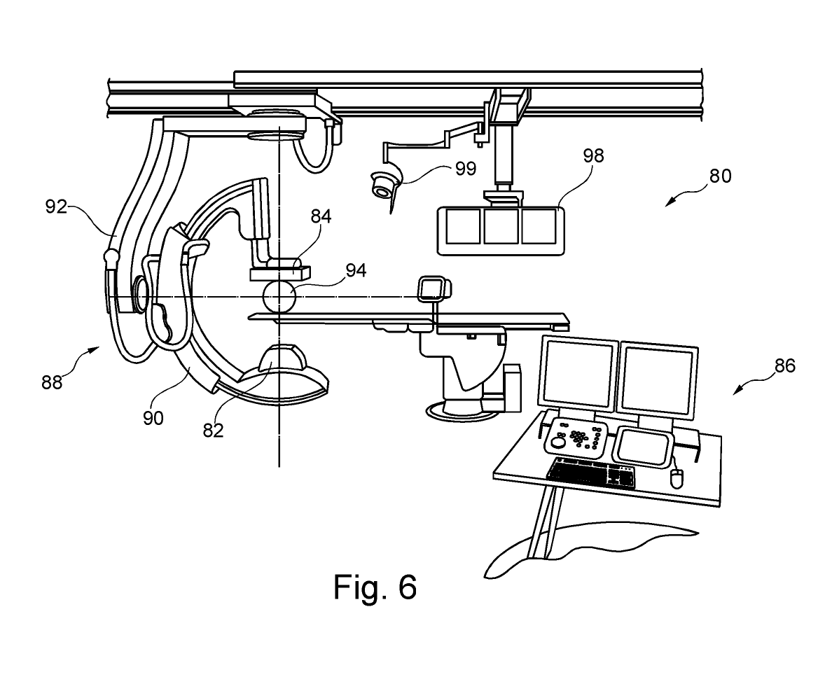

FIG. 6 shows an X-ray imaging system 80, comprising an X-ray source 82, an X-ray detector 84, and a processing unit 86. The X-ray source 82 is provided as an X-ray tube according to one of the above mentioned examples. The processing unit 86 is provided to control the rotation of the anode and the balancing of the anode by the active balancing means.

For example, the X-ray imaging system comprises a C-arm structure 88 with a C-arm 90, to which ends the X-ray source 82 and the X-ray detector 84 are mounted. The C-arm 90 is supported by a movable support structure 92, thus allowing a free movement around an object 94, for example a patient, arranged on a support surface 96. Further, display arrangements 98 are provided, in combination also with lighting equipment 99.

Of course, also other X-ray systems are provided, such as a CT system with a gantry on which an X-ray tube is rotating around an object, e.g. a patient, together with an oppositely arranged detector.

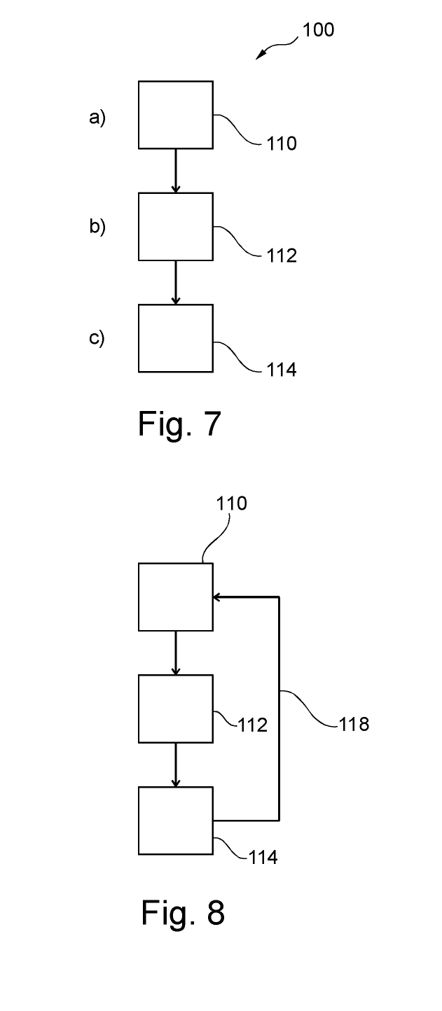

As can be seen in FIG. 7, also a method 100 for actively balanced rotation of an anode of an X-ray tube is provided, comprising the following steps: In a first step 110, an anode arrangement is rotated. In a second step 112, an imbalance is detected. In a third step 114, active balancing means are adapted depending on the detected imbalance. For the rotation, a bearing arrangement is provided as a fixed bearing of the rotating anode arrangement for supporting the rotating anode arrangement. The active balancing means are electro-magnetic balancing means. In the third step 114, the active balancing means are providing and applying magnetic eccentricity forces to the rotating arrangement.

The first step 110 is also referred to as step a), the second step 112 as step b) and the third step 114 as step c).

According to a further example, shown in FIG. 8, the application of the magnetic eccentricity forces to the rotating arrangement results in compensating the detected imbalance, which is indicated with a loop-like arrow 118.

In another exemplary embodiment of the present invention, a computer program or a computer program element is provided that is characterized by being adapted to execute the method steps of the method according to one of the preceding embodiments, on an appropriate system.

The computer program element might therefore be stored on a computer unit, which might also be part of an embodiment of the present invention. This computing unit may be adapted to perform or induce a performing of the steps of the method described above. Moreover, it may be adapted to operate the components of the above described apparatus. The computing unit can be adapted to operate automatically and/or to execute the orders of a user. A computer program may be loaded into a working memory of a data processor. The data processor may thus be equipped to carry out the method of the invention.

This exemplary embodiment of the invention covers both, a computer program that right from the beginning uses the invention and a computer program that by means of an up-date turns an existing program into a program that uses the invention.

Further on, the computer program element might be able to provide all necessary steps to fulfil the procedure of an exemplary embodiment of the method as described above.

According to a further exemplary embodiment of the present invention, a computer readable medium, such as a CD-ROM, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the Internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. An X-ray tube with an active balancing arrangement, comprising:
a rotating anode arrangement;
a bearing arrangement;
a driving arrangement for rotating the anode arrangement;
an imbalance detection arrangement; and
active balancing means;
wherein the bearing arrangement is provided as a fixed bearing of the rotating anode arrangement for supporting the rotating anode arrangement;
wherein the imbalance detection arrangement is configured to detect an imbalance of the anode;
wherein the active balancing means are electro-magnetic balancing means configured to provide a magnetic field and to apply magnetic eccentricity forces to the rotating arrangement.

2. X-ray tube according to claim 1, wherein a control unit is provided; and
wherein the active balancing means are controlled according to signals provided by the imbalance detection arrangement.

3. X-ray tube according to claim 1, wherein the active balancing means comprise at least three balancing arrangements provided in at least two different planes, which planes are perpendicular to an axis of rotation.

4. X-ray tube according to claim 1, wherein the driving arrangement comprises a rotor and a stator; and
wherein the active balancing means are configured to act upon magnetically activatable parts of the rotor.

5. X-ray tube according to claim 1, wherein the driving arrangement comprises a rotor and a stator; and
wherein the active balancing means are provided integrally with the stator.

6. X-ray tube according to claim 1, wherein the magnetic eccentricity caused by the active balancing means is adaptable in position and amplitude.

7. An X-ray imaging system, comprising:
an X-ray source;
an X-ray detector; and
a processing unit;
wherein the X-ray source is provided as an X-ray tube according to claim 1; and
wherein the processing unit is provided to control the rotation of the anode and the balancing of the anode by the active balancing means.

8. A method for actively balanced rotation of an anode of an X-ray tube, comprising the following steps:
a) rotating an anode arrangement;
b) detecting an imbalance;
c) adapting active balancing means depending on the detected imbalance;
wherein for the rotation, a bearing arrangement is provided as a fixed bearing of the rotating anode arrangement for supporting the rotating anode arrangement; and
wherein the active balancing means are electro-magnetic balancing means; and
wherein in step c), the active balancing means are providing and applying magnetic eccentricity forces to the rotating arrangement.

9. Method according to claim 8, wherein the application of the magnetic eccentricity forces to the rotating arrangement results in compensating the detected imbalance.

10. A computer program element which, when being executed by a processing unit, is adapted to perform the method of claim 8.

11. A computer readable medium having stored the program element of claim 10.
